(19) United States
(12) Patent Application Publication
(10) Pub. No.: US 2013/0286298 A1
(43) Pub. Date: Oct. 31, 2013

(54) TELEVISION AND ELECTRONIC APPARATUS

(71) Applicant: KABUSHIKI KAISHA TOSHIBA, Tokyo (JP)

(72) Inventors: Izen Sakuma, Akishima-shi (JP); Minoru Enomoto, Higashiyamato-shi (JP)

(73) Assignee: KABUSHIKI KAISHA TOSHIBA, Tokyo (JP)

(21) Appl. No.: 13/734,136

(22) Filed: Jan. 4, 2013

(30) Foreign Application Priority Data
Apr. 25, 2012 (JP) 2012-100298

(51) Int. Cl. H04N 5/64

(52) U.S. Cl. CPC H04N 5/64
USPC 348/836

(57) ABSTRACT

According to one embodiment, a television includes, a housing, a supporting portion, a display panel, a frame fitted with the display panel on one surface thereof, and inclined relative to the display panel, a printed circuit board which is mounted on the other surface of the frame opposite to the one surface and extends substantially parallel to the frame, a connector for external connection disposed nearer to the first end portion than a substantially middle portion of the printed circuit board in a direction connecting the first and second end portions, and a speaker includes an output section located nearer to the first end portion than the display panel and the frame in the housing.

### CROSS-REFERENCE TO RELATED APPLICATIONS

This application is based upon and claims the benefit of priority from prior Japanese Patent Application No. 2012-100298, filed Apr. 25, 2012, the entire contents of which are incorporated herein by reference.

### FIELD

Embodiments described herein relate generally to a television and an electronic apparatus comprising a frame.

### BACKGROUND

Some known liquid-crystal televisions and the like are integrated with a DVD device.

If a housing of a television does not have a frame therein, the television may not be strong enough as a whole. Thus, there has been a need for televisions with improved rigidity.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of a television as an example of an electronic apparatus according to a first embodiment, taken in a direction where a display panel is visible;

FIG. 2 is an exemplary perspective view of the television shown in FIG. 1, taken in the opposite direction to the direction where the display panel is visible;

FIG. 3 is an exemplary plan view showing the television of FIG. 1 with a second shell removed;

FIG. 4 is an exemplary plan view showing the television of FIG. 3 with a reinforcing plate removed;

FIG. 5 is an exemplary enlarged perspective view showing a fan unit of the television of FIG. 3 and its surroundings;

FIG. 6 is an exemplary sectional view taken along line F6-F6 of FIG. 4;

FIG. 7 is an exemplary sectional view taken along line F7-F7 of FIG. 4;

FIG. 8 is an exemplary sectional view taken along line F8-F8 of FIG. 4; and

FIG. 9 is an exemplary sectional view showing the television of FIG. 1 in an operating state or standing position.

### DETAILED DESCRIPTION

Various embodiments will be described hereinafter with reference to the accompanying drawings.

In general, according to one embodiment, a television includes, a housing, a supporting portion, a display panel, a frame disposed in the housing, fitted with the display panel on one surface thereof, and inclined relative to the display panel so that a gap between the frame and the display panel increases as the distance from the first end portion decreases, a printed circuit board which is mounted on the other surface of the frame opposite to the one surface and extends substantially parallel to the frame, a connector for external connection disposed nearer to the first end portion than a substantially middle portion of the printed circuit board in a direction connecting the first and second end portions, and a speaker includes an output section located nearer to the first end portion than the display panel and the frame in the housing.

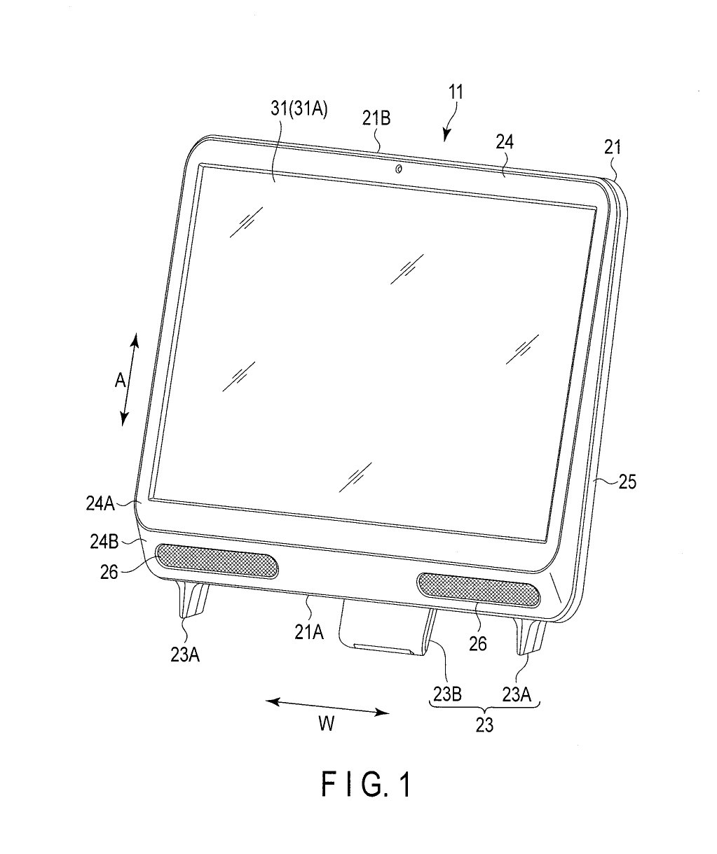

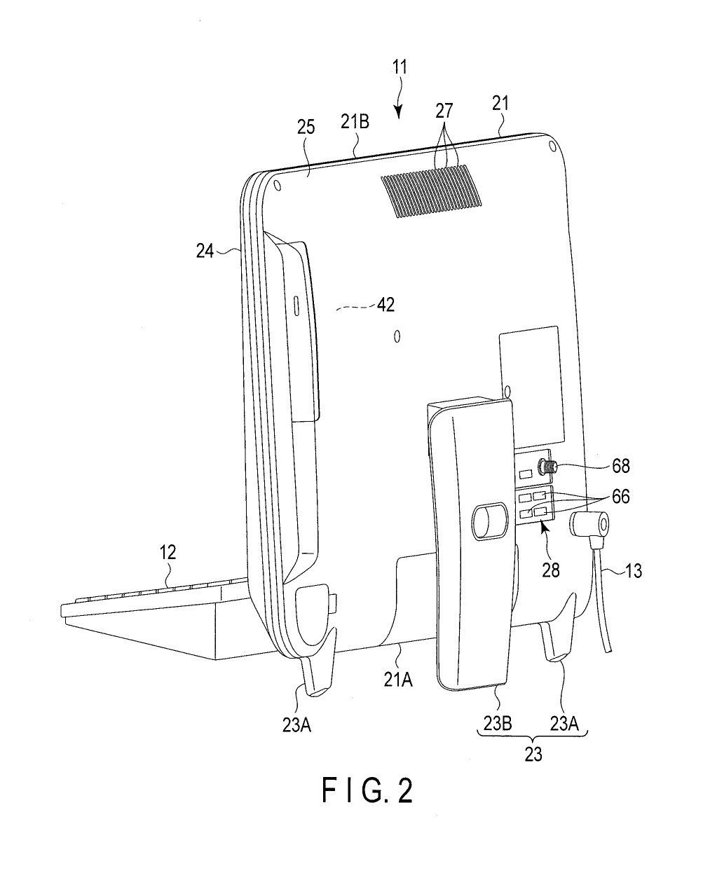

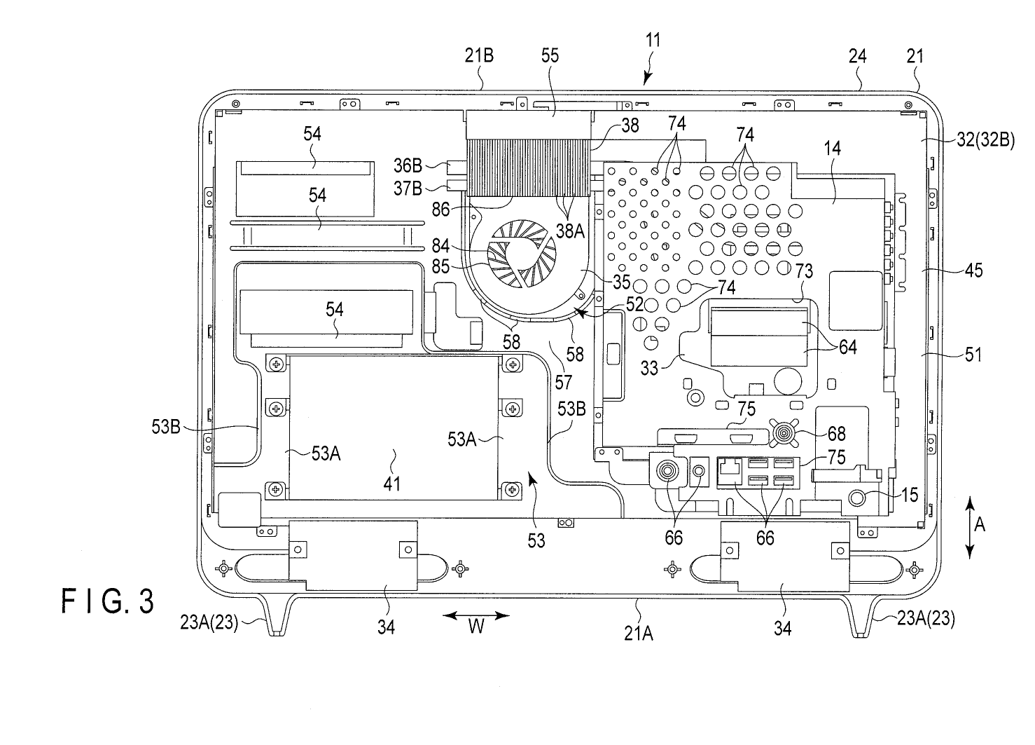

A first embodiment of an electronic apparatus will now be described with reference to FIGS. 1 to 9. As shown in FIG. 1, a television (television receiver, receiver, broadcast-wave receiving apparatus, receiving apparatus, television-type data processor, television-type computer, computer, or all-in-one computer) 11 as an example of the electronic apparatus according to the present embodiment is a display device having a substantially oblong (or rectangular, flat box-like, or oblong as viewed from the front) external appearance. The television 11 of the present embodiment can be used solely as a television, making use of its television function. If a keyboard 12, such as that shown in FIG. 2, is combined, the television 11 can also be used as a computer (personal computer). As shown in FIG. 2, moreover, an anti-theft wire 13 can be attached to the television 11. For example, a reinforcing plate 14 (described later) is formed with an orifice 15 (FIG. 3) to which an engaging portion of the wire 13 can be anchored. Alternatively, the orifice 15 may be formed in a frame 32, which will be described later.

As shown in FIGS. 1, 2 and 9, the television 11 comprises a housing 21 and supporting portion (stand or leg portion) 23, which is set on an installation surface 22 and supports the housing 21 in a standing position. The supporting portion 23 comprises a pair of first portions 23A and a second portion 23B. The first portions 23A are disposed integrally with the housing 21 at a first end portion 21A, which will be described later. The second portion 23B is disposed on the surface of the housing 21 opposite to that surface on which a display panel 31 is disposed. The first portions 23A are located individually near corner portions of the housing 21 and spaced apart from each other in a longitudinal direction (left-right direction) W. The second portion 23B is disposed so that it can rotate relative to the surface of the housing 21 opposite to the surface on which the display panel 31 is disposed and can be fixed at an arbitrary angle.

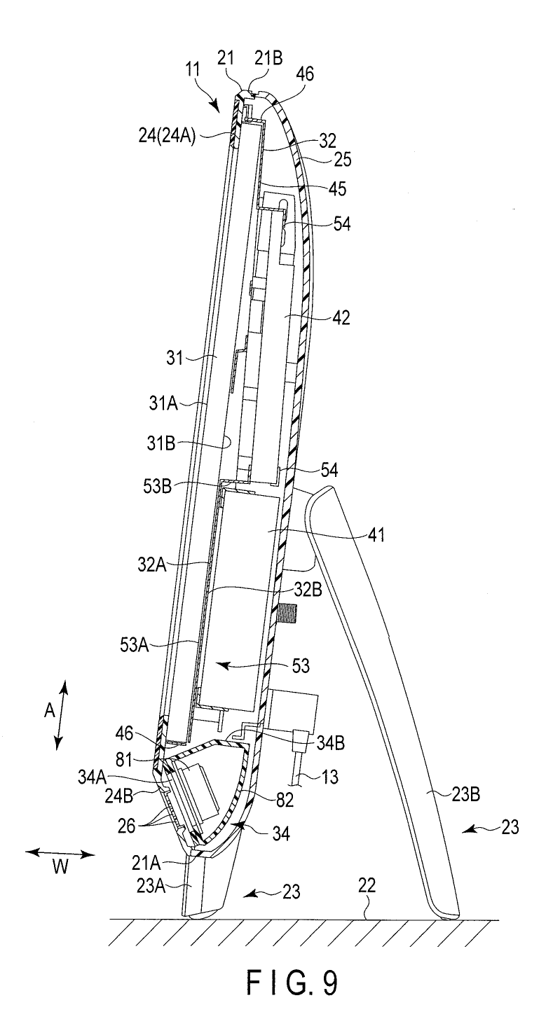

In an operating state, the housing 21 is inclined relative to the installation surface 22, as shown in FIG. 9. As shown in FIGS. 1 and 9, the housing 21 comprises the first end portion 21A located near the installation surface 22 and a second end portion 21B on the opposite side to the first end portion 21A. As shown in FIG. 2, the housing 21 comprises a first (front) shell 24 that covers the side of one surface 32A of the frame 32 and a second (rear) shell 25 that covers the side of the other surface 32B of the frame 32. As shown in FIG. 1, the first shell 24 comprises a main portion (frame portion) 24A with a square aperture through which the display panel 31 is externally exposed and a sloping portion 24B inclined relative to the main portion 24A and display panel 31. The sloping portion 24B is formed with openings 26 through which sound from speakers 34 can be externally emitted from the housing 21. When in the operating state, as shown in FIG. 9, the openings 26 are arranged along (or substantially parallel to) the installation surface 22.

As shown in FIG. 2, the second shell 25 comprises exhaust holes 27 and exposure aperture 28 through which connectors 66 are externally exposed. The exhaust holes 27 are disposed near the second end portion 21B.

As shown in FIGS. 3, 4 and 7, the television 11 comprises, in its housing 21, the display panel 31, the frame 32, a printed circuit board 33, the reinforcing plate 14, a pair of speakers 34, a fan unit 35, first and second heat pipes 36 and 37, a fin unit 38, a hard disk drive 41, an optical disc drive 42, a wireless LAN module 43, and a plurality of antennas 44. The display panel 31 is in the form of a flat plate (having a sheet-like or flat face), which comprises a first surface 31A, for use as a display screen on which an image is displayed, and a second surface 31B on the opposite side to the first surface 31A. The frame 32 is inclined relative to the display panel 31. The printed circuit board 33 is mounted on the other surface 32B of the frame 32 so that it extends along (or substantially parallel to) the frame 32. The reinforcing plate 14 is secured to the other surface 32B of the frame 32 so that the printed circuit board 33 is sandwiched between them. The speakers 34 are located near the side of the first end portion 21A. The fan unit 35 is mounted on the other surface 32B of the frame 32 and serves to externally discharge air warmed in the housing 21. The first and second heat pipes 36 and 37 serve to expedite cooling of heating components on the printed circuit board 33. The fin unit 38 is attached to the respective other end portions 36B and 37B of the heat pipes 36 and 37. The hard disk drive 41 and optical disc drive 42 are electrically connected to the printed circuit board 33. The wireless LAN module 43 is mounted on and electrically connected to the printed circuit board 33. The antennas 44 are connected to the wireless LAN module 43.

Although the display panel 31 is, for example, a liquid-crystal display panel, it may be of another type, such as a plasma display panel, organic electroluminescent display panel, plastic display panel, sheet display panel, etc. The display panel 31 is electrically connected to the printed circuit board 33. The display panel 31 is secured to the frame 32 by fixing members, such as screws or hooks. The display panel 31 is accommodated in the housing 21 so that it extends along the inner surface of the housing 21 (or near the surface of the housing 21).

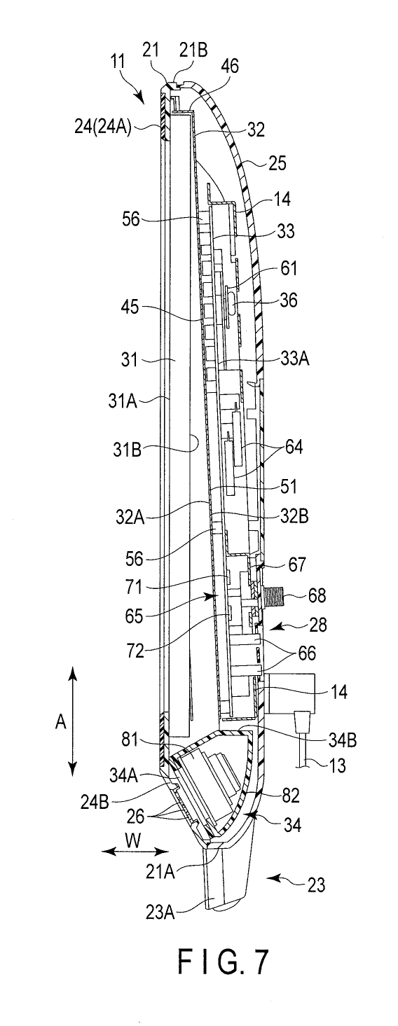

The frame 32 is formed by bending (or pressing) a metal material (metal plate) such as iron into a predetermined shape. As shown in FIG. 7 and the like, the frame 32 is inclined relative to the display panel 31 so that a gap between the frame 32 and display panel 31 increases as a whole as the distance from the first end portion 21A decreases. The frame 32 comprises the one surface 32A on which the display panel 31 is mounted and the other surface 32B opposite to the one surface 32A. The other surface 32B is mounted with the printed circuit board 33, reinforcing plate 14, fan unit 35, hard disk drive 41, optical disc drive 42, etc.

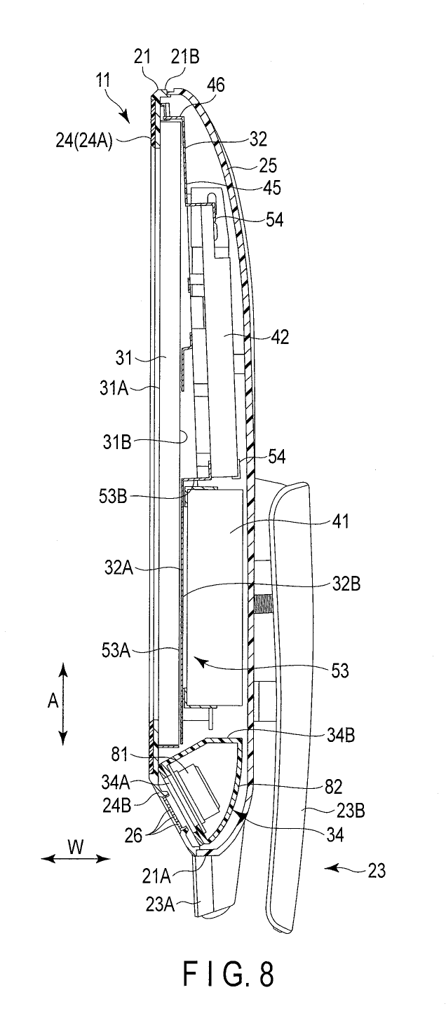

As shown in FIGS. 7 and 8, the frame 32 comprises a body portion 45, inclined relative to the display panel 31, and an edge portion 46 raised from the outer edge portion of the body portion 45. The angle between the body portion 45 and edge portion 46 is about 90°. As shown in FIG. 7, the dimension of the frame 32 on the side of the first end portion 21A in a thickness direction T is twice or thrice that of the frame 32 on the side of the second end portion 21B.

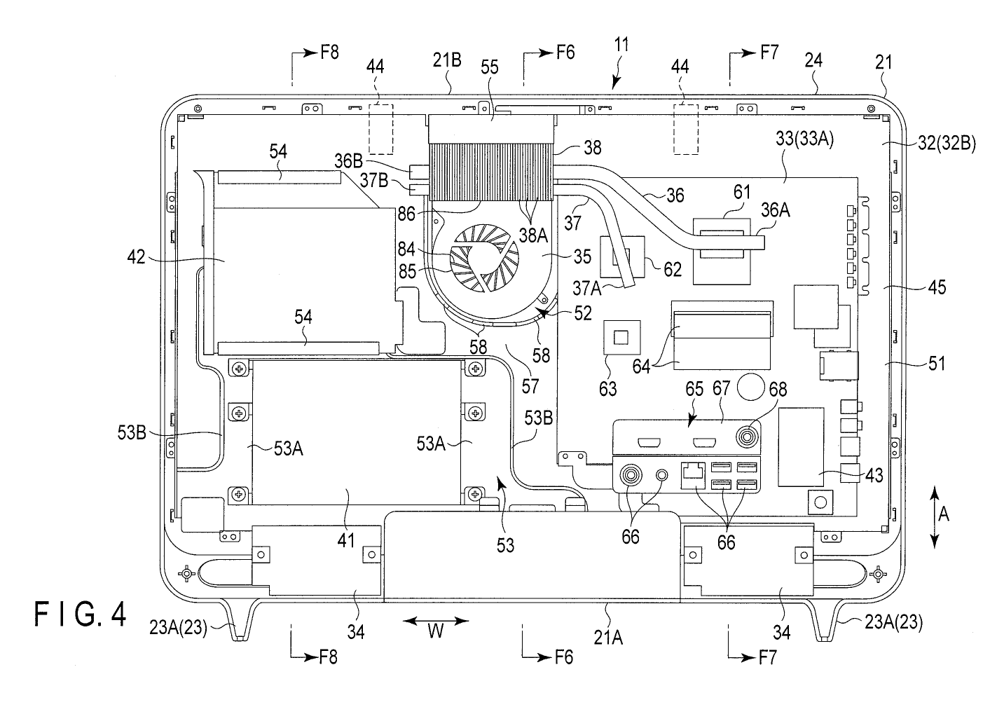

As shown in FIGS. 4, 6, 7, 8, etc., the body portion 45 of the frame 32 comprises a mounting surface 51, first hollow portion 52, second hollow portion 53, attachment portions 54, and guide portion 55. The mounting surface 51 is inclined relative to the display panel 31. The first and second hollow portions 52 and 53 serve to accommodate the fan unit 35 and hard disk drive 41, respectively. The optical disc drive 42 is attached to the attachment portions 54. The guide portion 55 is disposed near the first hollow portion 52. A plurality of studs 56 for securing the printed circuit board 33 are disposed on the mounting surface 51.

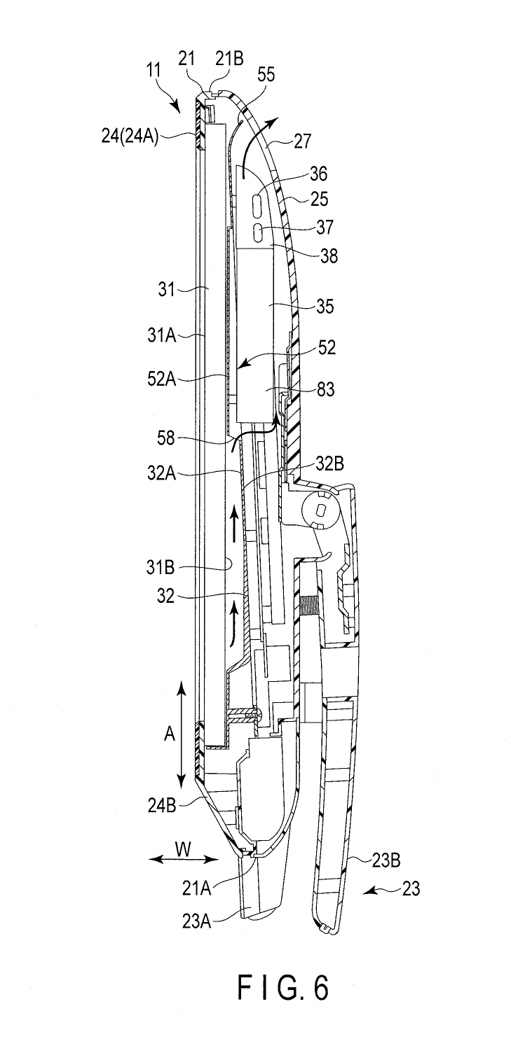

As shown in FIG. 6, the first hollow portion 52 is depressed relative to a surrounding portion 57 of the frame 32 toward the display panel 31. As shown in FIGS. 3 and 4, the first hollow portion 52 is disposed nearer to the second end portion 21B than a substantially middle portion of the frame 32 in a direction A connecting the first and second end portions 21A and 21B. The first hollow portion 52 is disposed in a substantially middle portion in the longitudinal direction (left-right direction) W of the housing 21.

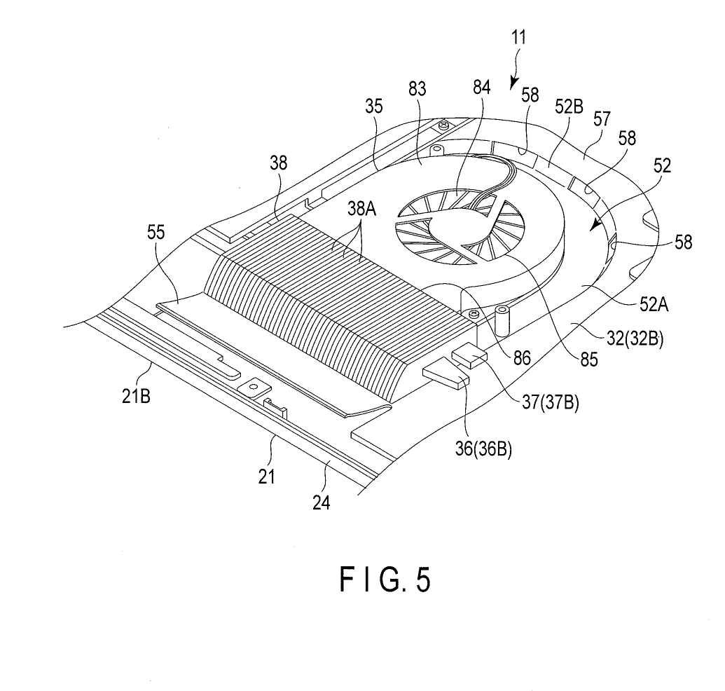

As shown in FIGS. 5 and 6, the first hollow portion 52 comprises a first bottom portion 52A extending along (or substantially parallel to) the display panel 31 and a first continuous portion 52B continuous with the first bottom portion 52A and surrounding portion 57. The fan unit 35 is mounted on the first bottom portion 52A on the other surface 32B of the frame 32. The first continuous portion 52B comprises a plurality of ventilation openings 58 arranged at regular intervals. As indicated by arrows in FIG. 6, air warmed by heat from the display panel 31 and accumulated between the display panel 31 and frame 32 is drawn in by the fan unit 35 through the openings 58 and externally discharged from the housing 21.

As shown in FIGS. 3, 4 and 8, the second hollow portion 53 is disposed nearer to the first end portion 21A than the substantially middle portion of the frame 32 in the direction connecting the first and second end portions 21A and 21B. As shown in FIG. 8, the second hollow portion 53 also comprises a second bottom portion 53A extending along (or substantially parallel to) the display panel 31 and a second continuous portion 53B continuous with the second bottom portion 53A and surrounding portion 57. The second hollow portion 53 is deep enough to accommodate the hard disk drive 41. The hard disk drive 41 is mounted on the second bottom portion 53A on the other surface 32B of the frame 32.

As shown in FIGS. 5 and 6, the guide portion 55 is disposed near an exhaust portion 86 of the fan unit 35 (or near the fin unit 38). The guide portion 55 is formed continuously with the first bottom portion 52A. It is curved toward the exhaust holes 27 and extends to the vicinity of the holes 27.

As shown in FIGS. 4 and 7, the printed circuit board 33 is secured to the studs 56 on the other surface 32B of the frame 32 by fixing members, such as screws or hooks. The printed circuit board 33 comprises a board body 33A, first heating component 61 (for example, a CPU), second heating component 62 (for example, a graphics chip), third heating component 63 (for example, a north bridge), solid-state drive (SSD) 64, tuner section 65, and connectors 66 for external connection. The SSD 64 is a storage device that comprises a plurality of flash memories and can be removably attached to the board body 33A. The tuner section 65 is disposed in a partial region of the board body 33A. Out of these elements, the first and second heating components 61 and 62 that produce much heat are disposed nearer to the second end portion 21B than a substantially middle portion of the printed circuit board 33 in the direction A connecting the first and second end portions 21A and 21B.

As shown in FIGS. 4 and 7, the tuner section 65 comprises a metallic shield housing 67, a pair of connection terminals 68 protruding from the top of the shield housing 67, and first and second tuners 71 and 72 on the inside of the shield housing 67. The first tuner 71 constitutes a part of, for example, a receiver circuit for analog/digital terrestrial broadcasting. Likewise, the second tuner 72 constitutes a part of, for example, a receiver circuit for satellite broadcasting. The connectors 66 are disposed nearer to the first end portion 21A than the substantially middle portion of the printed circuit board 33 in the direction A connecting the first and second end portions 21A and 21B.

As shown in FIGS. 3 and 7, the reinforcing plate 14 has a shape and size corresponding to those of the mounting surface 51 (or printed circuit board 33). The reinforcing plate 14 extends along (or substantially parallel to) the frame 32 (or mounting surface 51) and printed circuit board 33. The reinforcing plate 14 comprises a substantially square opening 73 located corresponding to the SSD 64, a plurality of circular heat radiating holes 74 located corresponding to the first to third heating components 61 to 63, and exposure aperture 75 through which the connectors 66 are exposed. An operator can attach the SSD 64 to and remove it from the board body 33A through the opening 73.

In the present embodiment, as shown in FIGS. 3 and 4, the heat radiating holes 74 are formed in two different sizes. The larger heat radiating holes 74 are located corresponding to the first heating component 61 (for example, the CPU) and third heating component 63 (for example, the north bridge). The presence of the larger heat radiating holes 74 serves to increase the opening area in the position where the first and third heating components 61 and 63 are disposed, thereby preventing heat (or warmed air) from stagnating in that position.

On the other hand, the smaller heat radiating holes 74 are located corresponding to the second heating component 62 (for example, the graphics chip). The second heating component 62 produces less heat than the first heating component 61 and can be fully cooled also by the second heat pipe 37. Therefore, heat (or warmed air) is prevented from stagnating in this region, and priority is rather given to the maintenance of the strength (rigidity) of the reinforcing plate 14 in this position. Thus, heat radiation and rigidity can be balanced by means of the heat radiating holes 74 in two sizes.

As shown in FIGS. 3 and 7, the reinforcing plate 14 reinforces the connection terminals 68 of the tuner section 65. Even if stress is applied to the terminals 68 as plugs or the like are inserted or removed, therefore, the reinforcing plate 14 absorbs the stress, thereby preventing it from being transmitted to the printed circuit board 33.

As shown in FIG. 3, the speakers 34 are disposed in a pair on the opposite sides of the interior of the housing 21 in the longitudinal direction (left-right direction) W along the first end portion 21A. As shown in FIGS. 7 and 8, each speaker 34 comprises a speaker body 81 and speaker box 82 surrounding the speaker body 81. The speaker 34 comprises an output section (output surface) 34A through which a sound emitted from the speaker body 81 is mainly output. The output section 34A faces the sloping portion 24B and extends along the inner surface of the sloping portion 24B. The output section 34A is located nearer to the first end portion 21A than the display panel 31 and frame 32. Each speaker 34 (or speaker box 82) comprises a portion 34B projecting from the ends of the display panel 31 and frame 32 on the side of the first end portion 21A toward the second end portion 21B. The portion 34B overlaps the display panel 31 and frame 32 with respect to the thickness direction T of the housing 21 (direction across or substantially perpendicular to the direction A connecting the first and second end portions 21A and 21B). Thus, the capacity of the speaker box 82 is maximized to achieve good sound quality.

As shown in FIGS. 3 and 4, the fan unit 35 comprises a fan housing 83, fan 84, air intake portion (air intake port) 85, and the exhaust portion (exhaust port) 86. The fan 84 is rotatably disposed in the fan housing 83. The air intake portion 85 is disposed on the side of the fan housing 83 opposite to the side facing the frame 32. The exhaust portion 86 is disposed in the fan housing 83 and directed toward the second end portion 21B of the housing 21. The fan unit 35 can draw in surrounding air from the air intake portion 85 and externally discharge it from the housing 21 through the exhaust portion 86, fin unit 38, and exhaust holes 27 of the second shell 25. The fan unit 35 is disposed nearer to the second end portion 21B than a substantially middle portion in the direction A connecting the first and second end portions 21A and 21B of the housing 21. The fan unit 35 is disposed in a substantially middle portion in the longitudinal direction (left-right direction) W of the housing 21.

As shown in FIG. 4, the first heat pipe 36 comprises one end portion 36A and the other end portion 36B. The one end portion 36A is connected to the first heating component 61 (for example, the CPU). The other end portion 36B is located between the fan unit 35 and exhaust holes 27 and connected to the fin unit 38. The second heat pipe 37 comprises one end portion 37A and the other end portion 37B. The one end portion 37A is connected to the second heating component 62 (for example, the graphics chip). The other end portion 37B is located between the fan unit 35 and exhaust holes 27 and connected to the fin unit 38.

The fin unit 38 comprises a plurality of fins 38A each in the form of a thin plate. Each fin 38A is thermally connected to the respective other end portions 36B and 37B of the first and second heat pipes 36 and 37. The heat pipes 36 and 37 are disposed nearer to the second end portion 21B than the substantially middle portion of the printed circuit board 33 in the direction A connecting the first and second end portions 21A and 21B.

As shown in FIG. 4, the hard disk drive (HDD) 41 comprises, for example, a 3.5-inch magnetic disk therein. The hard disk drive 41 is disposed nearer to the first end portion 21A than the substantially middle portion in the direction A connecting the first and second end portions 21A and 21B of the housing 21. The hard disk drive 41 is electrically connected to the printed circuit board 33.

The optical disc drive 42 can read and write various data, such as character data, images, videos, music, etc., from and to optical discs, such as Blu-ray discs, DVDs, CDs, etc. The optical disc drive 42 is disposed nearer to the second end portion 21B than the substantially middle portion of the frame 32 (or housing 21) in the direction A connecting the first and second end portions 21A and 21B. Further, the optical disc drive 42 is disposed nearer to the second end portion 21B than the hard disk drive (HDD) 41 in the direction A connecting the first and second end portions 21A and 21B. Further, the optical disc drive 42 is mounted on the attachment portions 54 of the frame 32 and electrically connected to the printed circuit board 33.

According to the present embodiment, the television 11 comprises the housing 21, supporting portion 23, display panel 31, frame 32, printed circuit board 33, connectors 66 for external connection, and speakers 34. The first end portion 21A is located near the installation surface 22. The second end portion 21B is located on the opposite side to the first end portion 21A. The supporting portion 23 is set on the installation surface 22 and supports the housing 21 in the standing position. The display panel 31 is accommodated in the housing 21 so that it extends along the inner surface of the housing 21. The frame 32 is disposed in the housing 21 and inclined relative to the display panel 31 so that the display panel 31 is attached to the one surface 32A and that the gap between the frame 32 and display panel 31 increases as the distance from the first end portion 21A decreases. The printed circuit board 33 is mounted on the other surface 32B of the frame 32 opposite to the one surface 32A and extends substantially parallel to the frame 32. The connectors 66 are disposed nearer to the first end portion 21A than the substantially middle portion of the printed circuit board 33 in the direction connecting the first and second end portions 21A and 21B. Each speaker 34 comprises the output section located in the housing 21 and nearer to the first end portion 21A than the display panel 31 and frame 32.

According to this arrangement, the gap between the display panel 31 and frame 32 increases as the distance from the first end portion 21A decreases. Thus, the printed circuit board 33 substantially parallel to the frame 32 can be separated from the display panel 31 as the distance from the first end portion 21A decreases. Further, the connectors 66 are located nearer to the first end portion 21A than the middle portion. Consequently, the connectors 66 can be separated from the display panel 31 and located near the housing 21 on the side of the other surface 32B of the frame 32. Thus, the appearance of the television 11 can be improved by reducing the depth of a hollow that is disposed in the housing 21 on the side of the other surface 32B of the frame 32 to allow the connectors 66 to be externally exposed. Further, the operability for the insertion and removal of the plugs or the like into and from the connectors 66 can be prevented from being degraded.

Furthermore, each speaker 34 comprises the portion 34B that projects from the ends of the display panel 31 and frame 32 on the side of the first end portion 21A toward the second end portion 21B. The portion 34B overlaps the display panel 31 and frame 32 with respect to the thickness direction T of the housing 21. According to this arrangement, the volume of each speaker 34 can be kept large enough to achieve good sound quality without increasing the thickness of the housing 21.

The housing 21 comprises the sloping portion 24B that faces the speakers 34 and is inclined relative to the display panel 31. The sloping portion 24B is formed with the openings 26, through which sound from the speakers 34 can be externally emitted from the housing 21, such that the openings 26 are arranged along the installation surface 22 when in the operating state. According to this arrangement, sound from the speakers 34 can be emitted toward a user, so that better sound quality can be achieved.

The television 11 comprises the first hollow portion 52 and fan unit 35. The first hollow portion 52 is disposed in the frame 32 so that it is depressed relative to the surrounding portion 57 of the frame 32 toward the display panel 31, on the side of the second end portion 21B with respect to the substantially middle portion of the frame 32 in the direction A connecting the first and second end portions 21A and 21B. The fan unit 35 is mounted on the other surface 32B in the first hollow portion 52 and serves to externally discharge air in the housing 21.

According to this arrangement, an installation space can be secured for the fan unit 35. Since the fan unit 35 is located remotely from or high above the installation surface 22, moreover, warm air accumulated in the upper part of the housing 21 can be smoothly externally discharged by the fan unit 35.

Further, the first hollow portion 52 comprises the bottom portion and the continuous portion, which is continuous with the bottom and surrounding portions and comprises the ventilation openings 58. According to this arrangement, warm air trapped between the display panel 31 and frame 32 can be delivered to the fan unit 35 through the openings 58. Thus, warm air can be prevented from stagnating between the display panel 31 and frame 32 and filling the housing 21 with heat.

The housing 21 comprises the first shell 24 that covers the side of the one surface 32A of the frame 32 and the second shell 25 that covers the side of the other surface 32B of the frame 32. The second shell 25 comprises the exhaust holes 27 through which air delivered from the fan unit 35 is externally discharged. The frame 32 comprises the guide portion 55 disposed near the exhaust portion 86 of the fan unit 35 and curved toward the exhaust holes 27. According to this arrangement, air from the fan unit 35 is guided toward the exhaust holes 27 by the guide portion 55, whereby the housing 21 can be prevented from being filled with heat (or warm air). Since the exhaust holes 27 can be disposed on the side of the second shell 25 that is not easily visible to the user, so that the appearance can be improved.

The television 11 comprises the heating component, disposed nearer to the second end portion 21B than the substantially middle portion of the printed circuit board 33 in the direction connecting the first and second end portions 21A and 21B, and the heat pipe comprising the one end portion 36A connected to the heating component and the other end portion 36B located between the fan unit 35 and exhaust holes 27.

According to this arrangement, the heating component can be disposed on the side of the second end portion 21B where the fan unit 35 is disposed, so that heat produced by the heating component can be efficiently externally discharged by virtue of not stagnating in any other portion in the housing 21. Further, the cooling efficiency for the heating component can be improved by the heat pipe.

The television 11 comprises the optical disc drive 42, second hollow portion 53, and hard disk drive 41. The optical disc drive 42 is mounted on the other surface 32B on the side of the second end portion 21B with respect to the substantially middle portion of the frame 32 in the direction connecting the first and second end portions 21A and 21B. The second hollow portion 53 is disposed in the frame 32 and depressed relative to the other portion 34B of the frame 32 toward the display panel 31, on the side of the first end portion 21A with respect to the substantially middle portion of the frame 32 in the direction A connecting the first and second end portions 21A and 21B. The hard disk drive 41 is mounted on the other surface 32B in the second hollow portion 53.

According to this arrangement, the relatively light optical disc drive 42 can be disposed on the sides of the second end portions 21B, and relatively heavy hard disk drive 41 can be disposed on the sides of the first end portions 21A. Thus, the center of gravity of the television 11 can be lowered, so that the television 11 can be prevented from toppling over, to thereby achieve improved stability. Further, the second hollow portion 53 can be formed deep, since it is disposed on the side of the second end portion 21B where the distance between the display panel 31 and frame 32 is long. Thus, the thick hard disk drive 41 can be located in the second hollow portion 53, so that the utilization ratio of the internal space of the housing 21 can be increased.

The television 11 comprises the reinforcing plate 14 extending substantially parallel to the printed circuit board 33 and attached to the frame 32 so that the board 33 is interposed between the reinforcing plate 14 and frame 32. According to this arrangement, the rigidity of the frame 32 can be improved by the reinforcing plate 14, and hence, the stability of the television 11 can be improved.

The electronic apparatus is not limited to the television 11 according to the embodiment described above. It is to be understood that the invention is also applicable to other electronic apparatuses, such as a cellphone, electronic book reader, etc. Further, the electronic apparatus is not limited directly to the above-described embodiment. In practice, the structural elements may be modified and embodied without departing from the spirit of the invention. Further, various inventions can be formed by appropriately combining a plurality of structural elements disclosed in the above-described embodiment. For example, some structural elements may be deleted from all the structural elements disclosed in the embodiment. Furthermore, structural elements of different embodiments may be combined as required.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a housing comprising a first end portion near an installation surface and a second end portion opposite the first end portion;
a supporting portion on the installation surface, the supporting portion configured to support the housing in a standing position;
a display panel in the housing and extending along an inner surface of the housing;
a frame in the housing, the frame connected to the display panel on a first surface of the frame, and the frame inclined relative to the display panel, wherein a distance between the frame and the display panel formed by the incline increases along a direction from the second end portion to the first end portion;
a printed circuit board on a second surface of the frame opposite to the first surface of the frame, the printed circuit board extending substantially parallel to the frame;
a connector configured to accept an external connection, the connector disposed nearer to the first end portion of the housing than a substantially middle portion of the printed circuit board along a direction from the first end portion to the second end portion; and
a speaker comprising an output section disposed nearer to the first end portion of the housing than the display panel and the frame in the housing.

2. The television of claim 1, wherein the speaker comprises a portion projecting from respective ends of the frame toward the second end portion from the first end portion, the projecting portion extending further in a thickness direction of the housing than the display panel and the frame.

3. The television of claim 2, wherein the housing comprises a sloping portion facing the speaker and inclined relative to the display panel, the sloping portion including an opening configured to emit sound from the speaker, the opening arranged along the installation surface when in an operating state.

4. The television of claim 3, further comprising a first hollow portion disposed in a substantially middle portion of the frame on the second end portion, the first hollow portion depressed relative to a first surrounding portion of the frame toward the display panel, and further comprising a fan unit on the second surface of the frame in the first hollow portion, the fan unit configured to discharge air from the housing.

5. The television of claim 4, wherein the first hollow portion comprises a bottom portion and a continuous portion contiguous with the bottom portion and the surrounding portion, the continuous portion comprising a ventilation opening.

6. The television of claim 5, wherein the housing further comprises a first shell covering the first surface of the frame and a second shell covering the second surface of the frame, the second shell comprises an exhaust hole through which the fan discharges air from the housing, and wherein the frame comprises a guide portion disposed near the exhaust hole of the fan unit and bent toward the exhaust hole.

7. The television of claim 6, comprising a heating component disposed nearer to the second end portion than the substantially middle portion of the printed circuit board along the direction from the first end portion to the second end portion, and a heat pipe comprising a first heat pipe end portion connected to the heating component and a second heat pipe end portion disposed between the fan unit and the exhaust hole.

8. The television of claim 7, further comprising an optical disc drive connected to the second end portion in the substantially middle portion of the frame in the direction from the first end portion to the second end portion, and a second hollow portion disposed in the substantially middle portion of the frame on the first end portion, the second hollow portion depressed relative to a second surrounding portion of the frame toward the display panel, and further comprising a hard disk drive connected to the second end portion in the second hollow portion.

9. The television of claim 8, further comprising a reinforcing plate extending substantially parallel to the printed circuit board and connected to the frame, wherein the printed circuit board is disposed between the reinforcing plate and the frame.

10. An electronic apparatus comprising:
a housing;
a supporting portion set on an installation surface, the supporting portion configured to support the housing in a standing position;
a display panel in the housing;
a frame in the housing, the frame connected to the display panel on a first surface of the frame, and the frame inclined relative to the display panel, wherein a distance between the frame and the display panel formed by the incline increases along a direction toward the installation surface;
a printed circuit board on a second surface of the frame opposite to the first surface of the frame, the printed circuit board extending along the frame; and
a connector disposed nearer to the installation surface than a substantially middle portion of the printed circuit board in a direction perpendicular to the installation surface.
